(19) United States
(12) Patent Application Publication
(10) Pub. No.: US 2007/0165673 A1
(43) Pub. Date: Jul. 19, 2007

(54) Method for reconstructing lost packets using a binary parity check

(75) Inventor: Dawei Huang, Brisbane (AU)

Correspondence Address: WILLIAMS, MORGAN & AMERSON, 10333 RICHMOND, SUITE 1100, HOUSTON, TX, 77042, US

(73) Assignee: Lucent Technologies

(21) Appl. No.: 11/366,211

(22) Filed: Mar. 2, 2006

(30) Foreign Application Priority Data
Dec. 29, 2005 (CN) 200510135745.X

(51) Int. Cl. H04J 3/24

(52) U.S. Cl. 370/474

(57) ABSTRACT

The present invention provides methods for reconstructing lost or corrupted packets. One embodiment of the method may include performing at least one parity operation on information associated with at least one first packet. The method may also include transmitting the information associated with at least one first packet and information indicative of the at least one parity operation. Another embodiment of the method may include accessing information associated with at least one first packet and information indicative of at least one parity operation performed on information associated with at least one first packet and at least one second packet. The method may also include determining information associated with the at least one second packet based on information associated with at least one first packet and information indicative of at least one parity operation performed on information associated with at least one first packet and the least one second packet.

This patent application claims priority to the previously filed Chinese Application No. 200510135745.X which was filed with the Chinese Patent Office on Dec. 29, 2005.

### BACKGROUND OF THE INVENTION

1. Field of the Invention

This invention relates generally to communication systems, and, more particularly, to reconstructing lost packets in communication systems.

2. Description of the Related Art

Packet-based communication networks, such as the Internet, have proven to be remarkably robust when transmitting non-delay sensitive information, such as electronic mail messages, web pages, and the like. Packet-based communication networks may also be used to transmit delay sensitive information (also known as real-time traffic) such as voice information. For example, the Voice over Internet Protocol (VoIP) may be used for voice communication over the Internet. However, heterogeneous networks such as the Internet are known to be lossy. For example, Internet packets are often lost in routers when the buffers in these routers become full. For another example, fiber optic cables in optical networks may be out of order, in which case packets intended to be transmitted along these fiber optic cables may be lost. Although lost packets including non-delay sensitive information may be recovered using various retransmission schemes, such as the Hybrid Automatic Repeat Request (HARQ) protocol, real-time traffic has much more stringent delay constraints that do not typically permit lost packets to be retransmitted.

Many techniques have been proposed to protect real-time traffic sent through heterogeneous packet-based networks against losses. One technique is to transmit the delay sensitive information simultaneously over more than one channel. Packets lost on one channel may then be recovered from the redundant channel(s). However, the probability that a packet will be lost is generally much less than one, so allocating dedicated redundant channels may reduce the efficiency of the communication system. Another technique is to transmit the packets using redundant codes. In theory, the raw data in a lost packet can be recovered using any portion of a transmitted code having a length equal to the raw data. A code that has this property may be referred to as a Maximal-Distance Separable (MDS) code. One example of an MDS code is the Reed-Solomon code. However, including raw data using MDS codes typically requires many complex and time-consuming operations, such as multiplication and addition on a Galois Field (2^{q}), which make these codes impractical for implementation in realistic communication systems.

In practice, redundant channel coding schemes generally add a moderate level of redundancy to the transmitted real-time traffic. For example, a simple coding scheme that combines information from several packets using an exclusive-OR (XOR) operation has been proposed. However, the simple XOR redundant coding scheme requires a relatively high level of redundancy and may significantly reduce the efficiency of the communication system. For example, a parity code may generate a single parity packet over two data packets so that if the original media packets are a, b, c, d, the packets generated by the sender may include a media stream of the a, b, c, d packets transmitted on a first channel in parallel with a forward error correction (FEC) stream transmitted over a second channel including information indicative of the parity functions f(a,b), f(c,d). In this example, the error correction scheme (note that the terms “scheme” and “code” may be used interchangeably in this context) introduces a 50% overhead, but if the packet b is lost, the information in packet a and the parity function f(a, b) can be used to recover the contents of packet b.

A nearly optimal code, which may be referred to as an (1+ε)-MDS code, has been proposed by Alon and Luby, “A Linear Time Erasure-Resilient Code with Nearly Optimal Recovery,” IEEE Transactions on Information Theory, vol. 42, No. 6, November 1996. However, the runtime required to implement the nearly optimal code is proportional to O(n/ε⁴) where n is the data length, and the packet length required to transmit the encoded data is proportional to O(log(1/ε)/ε⁴). Consequently, reducing the level of redundancy to an acceptable level, e.g., reducing the value of ε to something much less than one, requires very long run times and very long packet lengths.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided that may include performing at least one parity operation on information associated with at least one first packet. The method may also include transmitting the information associated with at least one first packet and information indicative of the at least one parity operation. In another embodiment of the present invention, a method is provided that may include accessing information associated with at least one first packet and information indicative of at least one parity operation performed on information associated with at least one first packet and at least one second packet. The method may also include determining information associated with the at least one second packet based on information associated with at least one first packet and information indicative of at least one parity operation performed on information associated with at least one first packet and the least one second packet.

Embodiments of the present invention based on parity check operations may be nearly optimal, e.g., they may comprise a nearly optimal (1+ε)-MDS code in which the value of ε can easily be less than 0.05. The encoding time for the coding scheme described above is approximately proportional to (1+ε), the decoding time is approximately proportional to the total number of packets and redundant packets, and the packet size is approximately proportional to (1+ε). Thus, the value of ε may be reduced to values much less than one without the relatively long run times and/or relatively long packet lengths typically required by conventional nearly optimal coding schemes. The computational complexity of implementations of embodiments of the present invention may also be reduced relative to conventional techniques for implementing nearly optimal codes.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a communication system, in accordance with the present invention;

FIG. 2 conceptually illustrates one exemplary embodiment of packets and redundant packets that may be transmitted in a communication system, such as the communication system shown in FIG. 1, in accordance with the present invention;

FIG. 3 conceptually illustrates one exemplary embodiment of a method of forming redundant information, in accordance with the present invention; and

FIG. 4 conceptually illustrates one exemplary embodiment of the method for reconstructing lost and/or corrupted packets.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

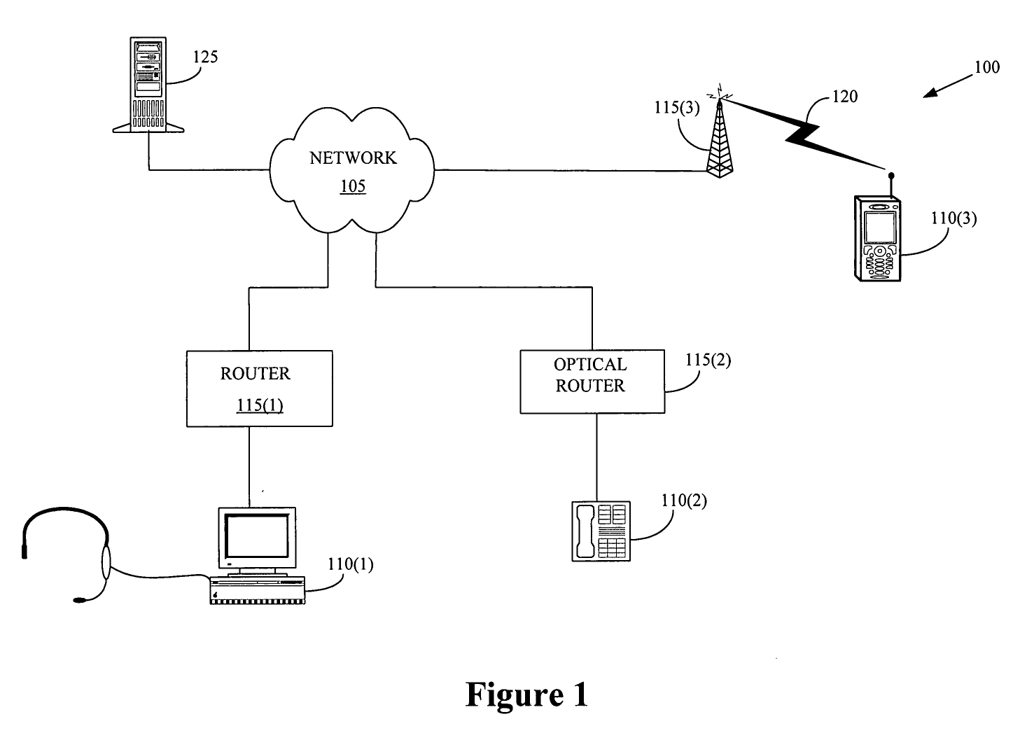

FIG. 1 conceptually illustrates one exemplary embodiment of a communication system 100. In the illustrated embodiment, the communication system 100 includes a network 105, which may include any combination of wired and/or wireless networks operating according to any combination of wired and/or wireless protocols. For example, the network 105 may include a portion that operates according to an Internet protocol and a portion that operates according to a Universal Mobile Telecommunication Services (UMTS) protocol. However, persons of ordinary skill in the art should appreciate that the present invention is not limited to these exemplary protocols. In alternative embodiments, the network 105 may include portions that operate according to a Public Switched Telephone Network (PSTN) protocol, a Plain Old Telephone System (POTS) protocol, a Code Division Multiple Access (CDMA, CDMA2000) protocol, a Bluetooth protocol, one of the IEEE 802 protocols, and the like. In one embodiment, the network 105 may also include an optical portion including one or more fiber-optic cables and other supporting equipment.

Various terminals 110(1-3) may be communicatively coupled to the network 105. The indices (1-3) may be used to refer to individual terminals 110(1-3) or subsets of the terminals 110(1-3). However, these indices may be dropped when the terminals 110 are referred to collectively. This numbering convention will be employed throughout the present application. In the illustrated embodiment, the terminals 110 include a desktop computer 110(1) that may be configured for Voice over Internet Protocol (VoIP) communication, a telephone 110(2) that may be configured to transmit signals over fiber-optic cables, and a mobile unit 110(3). The terminals 110 may be communicatively coupled to the network 105 through one or more interface devices 115. In the illustrated embodiment, the desktop computer 110(1) is communicatively coupled to the network 105 via a router 115(1), the telephone 110(2) is communicatively coupled to the network 105 via an optical router 115(2), and the mobile unit 110(3) is communicatively coupled to a base station router 115(3) over an air interface 120. Techniques for operating the terminals 110 and the interface devices 115 are known to persons of ordinary skill in the art and, in the interest of clarity, only those aspects of the operation of the terminals 110 and/or the interface devices 115 that are relevant to the present invention will be discussed further herein.

The communication system 100 may also include one or more servers 125 that are communicatively coupled to the network 105. The servers 125 may be used to provide information to the terminals 110 via the network 105. For example, the server 125 may host one or more web sites that may provide communications services to the terminals 110. The server 125 may also be used to receive, store, and/or transmit information provided by the terminals 110. For example, the server 125 may implement a voice messaging system that may receive a voice message from a terminal 110, store the voice message, and then transmit the voice message to another terminal 110 at a later time. However, persons of ordinary skill in the art having benefit of the present disclosure should appreciate that these exemplary functions of the server 125 are intended to be illustrative and not to limit the present invention.

Information is transmitted between the terminals 110, the interface devices 115, and/or the server 125 in the form of packets. For example, the network 105 may receive packets from the terminals 110, the interface devices 115, and/or the server 125 and may distribute packets to the terminals 110, the interface devices 115, and/or the server 125 according to an Internet protocol. For example, real-time applications implemented on one or more of the terminals 110, the interface devices 115, and/or the server 125 may transmit and/or receive packets according to various protocols such as the Real-time Transport Protocol/User Datagram Protocol (RTP/UDP). Exemplary real-time applications include VoIP applications, video streaming applications, and the like.

Packets may be lost or corrupted in virtually any portion of the communication system 100 including the network 105, the terminals 110, the interface devices 115, and/or the server 125, as well as in the wires, cables, fiber optic cables, air interfaces, and the like. Accordingly, redundant information may be transmitted and used to reconstruct lost or corrupted packets. In one embodiment, redundant information is formed by accessing one or more bits in the packets that include the information to be transmitted and performing at least one parity operation on the bits. For example, one bit in each of the packets to be transmitted may be accessed (e.g. read from a memory or a register or received as part of a data stream) and the bits may be combined using an exclusive-OR (XOR) operation to form the redundant information. The redundant information may be included in one or more redundant packets and transmitted with the original packets, e.g., over a single channel. If one of the original packets is determined to be lost and/or corrupted, the redundant information may be combined with the successfully received information to reconstruct the lost and/or corrupted packets.

Redundant packets may be formed at any location, or combination of locations, within the communication system 100. Lost and/or corrupted packets may also be reconstructed using the redundant information at any location, or combination of locations, within the communication system 100. For example, redundant packets may be formed in the terminals 110, the server 125, or any other location. Lost and/or corrupted packets may be reconstructed using the redundant information in the terminals 110, the interface devices 115, the server 125, or at some location within the network 105. Persons of ordinary skill in the art should also appreciate that these operations may be performed using hardware, firmware, software, or any combination thereof.

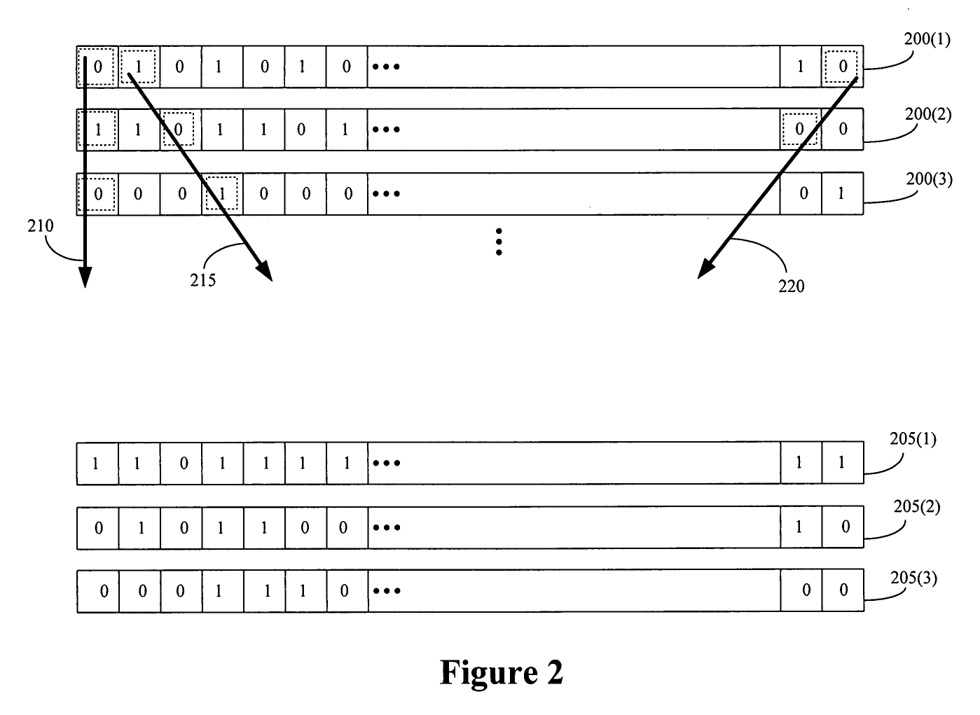

FIG. 2 conceptually illustrates one exemplary embodiment of packets 200 and redundant packets 205 that may be transmitted in a communication system, such as the communication system 100 shown in FIG. 1. In the illustrated embodiment, the packets 200 and the redundant packets 205 are depicted as separate packets that include information to be transmitted and redundant information formed using the information to be transmitted, respectively. However, persons of ordinary skill in the art should appreciate that the present invention is not so limited. In alternative embodiments, portions of the information to be transmitted and portions of the redundant information may be combined and transmitted together in one or more packets. For example, bits representative of the information to be transmitted and bits representative of the redundant information may be interleaved within a single packet.

In the illustrated embodiment, the values of the bits in the redundant packets 205 are determined by performing binary parity operations on bits selected from the packets 200. Persons of ordinary skill in the art having benefit of the present disclosure should appreciate that a parity operation may include any operation used to determine one or more parity bits associated with a data stream. For example, the redundant packet 205(1) may be formed by selecting the first bit (as indicated by the dashed boxes) from each of the packets 200, as indicated by the arrow 210. The selected bits may then be combined using a binary parity operation such as an XOR operation and the results of the binary parity operation may be stored as one or more bits in the redundant packet 205(1). For another example, the redundant packet 205(2) may be formed by selecting bits (as indicated by the dashed boxes) along a 45° line 215 through the packets 200, e.g., the second bit may be selected from the first packet 200(1), the third bit may be selected from the second packets 200(2), the fourth bit may be selected from the third packets 200(3), etc. The selected bits may then be combined using a binary parity operation such as an XOR operation and the results of the binary parity operation may be stored as one bit in the redundant packet 205(2). In the illustrated embodiment, the first bit in 205(2) is the same as the first bit in 200(3), the second bit in 205(2) is the XOR of the first bit in 200(2) and second bit in 200(3), the third bit in 205(2) is the XOR of the first bit in 200(1), second bit in 200(2) and third bit in 200(3), and so on. For yet another example, the redundant packet 205(3) may be formed by selecting bits (as indicated by the dashed boxes) along a 135° line 220 through the packets 200, e.g., the last bit may be selected from the first packet 200(1), the next-to-last bit may be selected from the second packets 200(2), etc. The selected bits may then be combined using a binary parity operation such as an XOR operation and the results of the binary parity operation may be stored as one or more bits in the redundant packet 205(3).

Although the bits in the redundant packets 205 are formed using an XOR operation, persons of ordinary skill in the art having benefit of the present disclosure should appreciate that the present invention is not limited to the XOR binary parity operation. In alternative embodiments, any parity operation may be used. For example, bytes may be used instead of bits as the unit and XOR's on each bit inside the byte may be recorded. This method may reduce the efficiency (increase the E described above and below), but may also make the computation parallel and faster. Persons of ordinary skill in the art having benefit of the present disclosure should also appreciate that the rules or algorithms for selecting bits from the packets 200 to form the redundant packets 205 are matters of design choice and not material to the present invention. Moreover, the number of packets 200 and/or the number of redundant packets 205, as well as the number of bits included in each packet 200 and/or redundant packet 205, are also matters of design choice and not material to the present invention.

Furthermore, although three redundant packets are used in the illustrated embodiment, the present invention is not limited to any particular number of redundant packets. In alternative embodiments, an arbitrary number of redundant packets may be selected. For example, packets may be selected so that each selected packet has one and only one intersection with each raw packet and each pair of selected packets has one and only one intersection between the two lines. Accordingly, for any M raw data packets, N protection packets may be selected to realize the so-called M+N protection. If any N packets within these M+N packets are lost, the contents of the M raw data packets may still be recovered using the N protection packets.

If one or more of the packets 200, or portions of the packets 200, are corrupted and/or lost during transmission, the redundant packets 205 may be used to reconstruct the lost and/or corrupted packets 200. For example, if 10 packets 200 including 10 bits are used to construct three redundant packets 205 including 10 bits of redundant information, then as much as 30% of the transmitted information may be reconstructed if it is lost and/or corrupted. For example, three lost or corrupted packets 200 may be reconstructed using the three redundant packets 205. Techniques for reconstructing the lost and/or corrupted information using the redundant packets 205 are known to persons of ordinary skill in the art and, in the interest of clarity, only those aspects of these techniques that are relevant to the present invention will be discussed further herein.

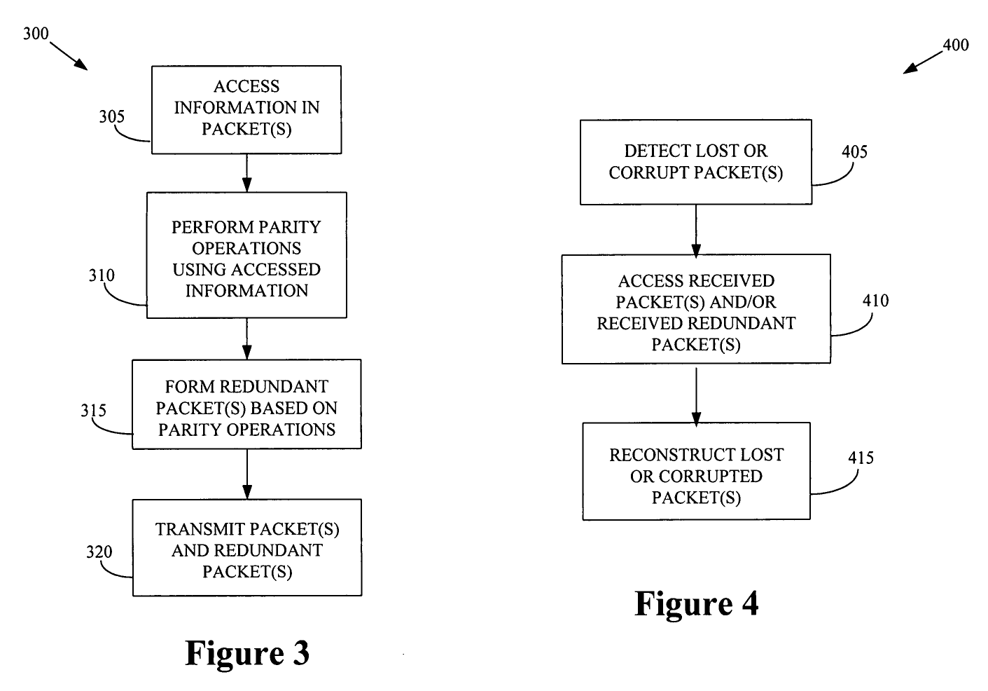

FIG. 3 conceptually illustrates one exemplary embodiment of a method 300 of forming redundant information. In the illustrated embodiment, information in one or more packets that are to be transmitted is accessed (at 305). For example, one or more bits in each of a plurality of packets that are to be transmitted to be accessed (at 305). Parity operations may then be performed (at 310) on the accessed information. For example, the bits from the plurality of packets may be combined using an exclusive-OR operation. The results of the parity operations may then be used to form (at 315) one or more redundant packets. For example, the results of the exclusive-OR operations may be used to form bits of the one or more redundant packets. The redundant packets may then be transmitted (at 320) along with the original packets.

FIG. 4 conceptually illustrates one exemplary embodiment of the method 400 for reconstructing lost and/or corrupted packets. In the illustrated embodiment, one or more packets may be determined (at 405) to be lost and/or corrupted. Techniques for determining whether or not a packet has been lost and/or corrupted are known to persons of ordinary skill in the art and, in the interest of clarity, will not be discussed further herein. In response to determining (at 405) that one or more of the packets was lost and/or corrupted, redundant packets associated with the lost and/or corrupted packets, as well as other successfully received packets, may be accessed (at 410). The lost and/or corrupted packets may then be reconstructed (at 415) using information in the redundant packets associated with the lost and/or corrupted packets, as well as information in the successfully received packets.

The techniques for forming redundant information and reconstructing lost and/or corrupted packets using the redundant information described above may have a number of advantages over conventional practice. The coding scheme based on the binary parity check operations described above is a nearly optimal (1+ε)-MDS code. For an XOR coding schemes ε=(M−L)/L, where M is a number of raw data packets or channels and L is the length of each raw data packet in bits. Accordingly, the value of ε can easily be less than 0.05. For an optical network, the coding schemes described above may provide M+N protection, where M is the number of pulses or channels used to transmit the raw information and N is the number of extra redundant pulses. The encoding time for the coding scheme described above is approximately proportional to (1+ε), the decoding time is approximately proportional to the total number of packets and redundant packets, and the packet size is approximately proportional to (1+ε). Thus, the value of E may be reduced to values much less than one without the relatively long run times and/or relatively long packet lengths typically required by conventional nearly optimal coding schemes. The computational complexity of implementations of embodiments of the present invention may also be reduced relative to conventional techniques for implementing nearly optimal codes. The coding scheme described above may therefore be used to provide redundant information for real-time applications such as VoIP, video streaming, other applications using RTP/UDP protocols, and the like. The techniques described above may also be used to provide optical path protection by considering each time-division-multiplexed timeslot as a single data element.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
performing at least one parity operation on information associated with at least one first packet; and
transmitting said information associated with at least one first packet and information indicative of said at least one parity operation.

2. The method of claim 1, comprising accessing said information associated with said at least one first packet.

3. The method of claim 2, wherein accessing said information associated with said at least one first packet comprises accessing information associated with a plurality of first packets.

4. The method of claim 3, wherein accessing said information associated with the plurality of first packets comprises accessing at least one bit from each of the plurality of first packets.

5. The method of claim 4, wherein accessing said at least one bit from each of the plurality of first packets comprises accessing at least one bit from at least one predetermined location in each of the plurality of first packets.

6. The method of claim 5, wherein accessing at least one bit from at least one predetermined location in each of the plurality of first packets comprises accessing a plurality of bits from a plurality of predetermined locations in each of the plurality of first packets.

7. The method of claim 1, wherein performing the parity operation comprises performing a binary parity operation.

8. The method of claim 7, wherein performing the binary parity operation comprises performing an exclusive-OR operation.

9. The method of claim 1, wherein transmitting said information indicative of the parity operation comprises forming at least one second packet based on said at least one parity operation.

10. The method of claim 9, wherein transmitting said information associated with said at least one first packet and information indicative of the parity operation comprises transmitting said at least one first packet and said at least one second packet.

11. The method of claim 1, wherein transmitting said information associated with said at least one first packet and information indicative of the parity operation comprises forming at least one third packet based on said information associated with said at least one first packet and said information indicative of the parity operation.

12. The method of claim 11, wherein transmitting said information associated with said at least one first packet and information indicative of the parity operation comprises transmitting said at least one third packet.

13. A method, comprising:
accessing information associated with at least one first packet and information indicative of at least one parity operation performed on information associated with at least one first packet and at least one second packet; and
determining information associated with said at least one second packet based on information associated with at least one first packet and information indicative of at least one parity operation performed on information associated with at least one first packet and said least one second packet.

14. The method of claim 13, wherein accessing information associated with said at least one first packet and information indicative of said at least one parity operation comprises receiving at least one third packet including said information associated with at least one first packet and information indicative of at least one parity operation.

15. The method of claim 14, wherein receiving said at least one third packet comprises receiving said at least one first packet.

16. The method of claim 13, wherein accessing said information associated with said at least one first packet and said information indicative of at least one parity operation performed on information associated with at least one first packet and at least one second packet comprises accessing information indicative of at least one binary parity operation performed on said information associated with at least one first packet and at least one second packet.

17. The method of claim 13, comprising determining that said at least one second packet is lost or corrupted.

18. The method of claim 17, wherein determining said information associated with said at least one second packet comprises determining said information associated with said at least one second packet in response to determining that said at least one second packet is lost or corrupted.

19. The method of claim 13, wherein determining said information associated with said at least one second packet comprises determining at least one bit associated with said at least one second packet.

20. The method of claim 19, wherein determining said at least one bit associated with said at least one second packet comprises reconstructing said at least one second packet.
